(19) United States
(12) Patent Application Publication
(10) Pub. No.: US 2026/0034555 A1
(43) Pub. Date: Feb. 5, 2026

(54) HIGH-TEMPERATURE FIRE SPRINKLER SHIELD WITH INTEGRATED MAGNETIC COUPLING

(71) Applicant: Benjamin Cook, Boynton Beach, FL (US)

(72) Inventor: Benjamin Cook, Boynton Beach, FL (US)

(21) Appl. No.: 19/284,155

(22) Filed: Jul. 29, 2025

Related U.S. Application Data
(60) Provisional application No. 63/678,433, filed on Aug. 1, 2024.

(51) Int. Cl. B05B 15/16; A62C 31/28; H01F 7/02

(52) U.S. Cl. CPC B05B 15/16; A62C 31/28; H01F 7/0252

(57) ABSTRACT

A high-temperature fire sprinkler shield with integrated magnetic coupling provides advanced protection for fire sprinkler heads in high-heat environments. Constructed from durable silicone with a thickness of 1.5 mm to 4 mm, this cover offers superior thermal insulation and resistance. The unitary body features a cylindrical sidewall extending from a planar base, creating a hollow cavity that encloses the sprinkler head. An integrated magnetic attachment mechanism ensures a secure and easy fit to the metallic bezel of the sprinkler, maintaining stability and thermal isolation. This invention addresses the limitations of traditional covers by effectively safeguarding sprinkler heads from heat-induced damage and accidental activation.

### CROSS-REFERENCE TO RELATED APPLICATIONS

This application claims the benefit or priority under 35 USC 119(e) of provisional patent application Ser. No. 63/678,433 filed Aug. 1, 2023, titled “A High-Temperature Fire Sprinkler Shield with Integrated Magnetic Coupling,” which is incorporated by reference in its entirety

### FIELD OF THE INVENTION

The present invention relates to fire sprinkler head covers.

### BACKGROUND

Fire sprinkler head covers are essential protective devices used during construction, renovation, and maintenance activities to safeguard fire sprinkler heads from damage and contamination. These covers typically function by temporarily enclosing the sprinkler head, thereby preventing debris such as dust, paint, or other particulates from obstructing the sprinkler's nozzles or triggering unintentional activation. Standard covers are also used to shield sprinkler heads from accidental impacts or environmental exposure that might occur during activities like drywall installation, painting, or minor repairs.

Conventional sprinkler head covers are commonly made from materials such as plastic, or in some cases metal. Plastic covers are often designed to be disposable, featuring snap-on or screw-on mechanisms that allow for easy installation and removal. These are typically used for light-duty applications where temporary protection from debris or paint is required. Metal covers, on the other hand, are more robust and suitable for environments where greater durability is necessary. They are often employed in industrial settings where there is a risk of mechanical impact. Both plastic and metal covers are available in various designs, including recessed models that align flush with the ceiling to protect concealed sprinkler heads while maintaining the aesthetic integrity of the surroundings.

While effective in preventing physical damage and contamination during regular maintenance and construction activities, traditional sprinkler head covers are generally inadequate for protection in high-heat environments. For example, during brazing, welding, or cutting operations, temperatures can rise significantly, posing a risk to the integrity of these covers. Plastic covers may melt or deform under such conditions, while metal covers, although more resistant to heat deformation, can conduct heat to the sprinkler head and lead to accidental activation or thermal damage. These shortcomings are especially critical in HVAC applications, where brazing is a commonly used metal-joining process for connecting piping and components.

Brazing, in particular, presents unique challenges for sprinkler protection. Unlike welding, brazing joins metals using a filler metal with a lower melting point, allowing for precise, clean joints with minimal thermal distortion. It is often preferred in HVAC installations for its ability to join dissimilar metals and form strong, reliable connections. However, the heat required during brazing still poses a threat to nearby fire sprinkler components. Conventional covers are not designed to mitigate these thermal risks, leaving sprinkler heads vulnerable during such operations.

Thus, a need exists in the market for a lightweight, heat-resistant, magnetic sprinkler cover that can withstand the high temperatures encountered during brazing and other similar processes. This invention aims to address the limitations of current sprinkler head covers by providing a protective solution specifically engineered to shield sprinkler heads not only from debris and physical damage but also from high-heat exposure. The result is a more comprehensive and reliable form of protection, particularly suited for HVAC technicians and other professionals working in thermally intensive environments.

### SUMMARY OF THE INVENTION

The invention disclosed herein provides a thermally insulating and heat-resistant fire sprinkler cover. The cover comprises a unitary body forming a cylindrical sidewall extending upwardly from a planar circular base, thereby creating a hollow internal cavity with an open upper aperture configured to receive a sprinkler head of a fire sprinkler system. A circular flange extends outwardly from the upper boundary of the aperture, and internal magnetic means are positioned within the flange to magnetically couple the cover to the metallic bezel of the sprinkler head. The unitary body is formed from a high-temperature resistant silicone material having a thickness of approximately 1.5 mm to 7 mm.

The present invention offers several key functional advantages that enhance its utility in high-temperature environments. Constructed from high-quality, heat-resistant silicone rubber, the sprinkler cover is capable of withstanding the intense thermal conditions generated by torches and other heating tools, thereby helping to prevent accidental activation or damage to fire sprinklers. Embedded internal magnets enable secure and consistent attachment to the metallic bezel of the sprinkler head, ensuring reliable protection during HVAC operations. The device is designed for repeated use without degradation of its protective properties, offering durability and long-term performance. Additionally, the cover is lightweight, compact, and easily transportable, making it a practical and essential component of an HVAC technician's standard toolkit.

It is an object of the present invention to provide a system that enhances thermal protection for fire sprinkler heads, effectively insulating them from high temperatures and thermal hazards encountered during activities such as welding or brazing.

It is yet another object of the present invention to provide a fire sprinkler cover with a secure and reliable attachment mechanism that utilizes internal magnets to connect with the metallic bezel of the sprinkler head, ensuring a stable and easily removable connection.

It is a further object of the invention to employ durable, flexible silicone material to provide both heat resistance and reusability, enabling reliable, long-term protection in thermally intensive work environments.

The invention further provides a lightweight and compact form factor suitable for transport and deployment by HVAC technicians. The combination of thermal insulation, magnetic retention, and material resilience makes the device particularly suitable for repeated use in high-temperature service contexts.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates a bottom 3D isometric view of a high-temperature fire sprinkler shield.

FIG. 2 illustrates a top 3D isometric view of the high-temperature fire sprinkler shield.

FIG. 3 illustrates a bottom view of the high-temperature fire sprinkler shield.

FIG. 4 illustrates a top view of the high-temperature fire sprinkler shield.

FIG. 5 illustrates a cross section of the high-temperature fire sprinkler shield installed onto a metallic bezel of the fire sprinkler of the fire sprinkler system.

FIG. 6 illustrates view shown in FIG. 5, shown as a side elevational view.

FIG. 7 illustrates a conceptual view of a sprinkler under high-heat without the high-temperature fire sprinkler shield.

FIG. 8 illustrates a conceptual view of a user installing the high-temperature fire sprinkler shield.

FIG. 9 illustrates a conceptual view of a sprinkler under high-heat with the high-temperature fire sprinkler shield.

### DETAILED DESCRIPTION OF THE INVENTION

The innovative fire sprinkler cover described herein represents a significant advancement in the protection of fire sprinkler systems, particularly in environments where exposure to high temperatures and thermal hazards is prevalent. Unlike traditional protective covers that primarily shield against mechanical damage and contamination, this cover is specifically structured to provide both thermal insulation and heat resistance, ensuring effective protection during high-heat activities such as welding or brazing.

In this context, brazing is especially relevant due to its frequent application in HVAC installations. Brazing offers several advantages over other metal-joining techniques such as welding. Unlike welding, brazing does not melt the base metals being joined, which allows for tighter tolerances, cleaner joints, and reduced thermal distortion due to more uniform heating. Moreover, brazing enables the joining of dissimilar metals or even metalized ceramics and supports the assembly of complex components in a cost-effective and high-precision manner.

Brazing is a process in which two or more metal components are joined by melting and flowing a filler metal into the joint. The filler metal, which has a lower melting point than the base metals, is drawn into the joint by capillary action. It is typically heated just above its melting temperature and protected by a flux or controlled atmosphere. Once melted, the filler wets the base materials and solidifies upon cooling, creating a strong bond.

This method differs from welding, which requires melting the base materials themselves, often leading to increased thermal stress and the need for post-processing. Brazing also differs from soldering by using higher temperatures and requiring more precise part fitment, resulting in significantly stronger joints. Due to these characteristics, brazing is widely adopted in HVAC work but presents substantial thermal hazards to nearby components, particularly fire sprinklers.

To address this challenge, the present invention is specifically engineered to shield fire sprinkler heads from heat exposure during brazing operations. It is especially useful for HVAC technicians operating in confined spaces where metal-joining occurs in close proximity to active sprinkler systems.

The fire sprinkler cover is constructed as a unitary body comprising a cylindrical sidewall extending upwardly from a planar circular base. This configuration defines a hollow internal cavity with an open upper aperture configured to receive and enclose a fire sprinkler head. The unitary construction ensures consistent material properties throughout the cover, contributing to both its structural stability and thermal performance.

The cover is fabricated from high-quality silicone material with a thickness ranging from approximately 1.5 mm to 4 mm. This material is chosen for its superior thermal insulation, heat resistance, flexibility, and lightweight properties. The specified thickness range provides an optimal balance between insulation effectiveness and usability. Importantly, the selected weight and thickness also ensure compatibility with the magnetic retention system, the cover remains light enough to be securely held in place via magnetic attraction to the metallic bezel of the sprinkler head.

The hollow cavity, in combination with the insulating properties of silicone, creates a thermal buffer that isolates the sprinkler head from direct exposure to heat sources. The sidewall and base effectively encapsulate the sprinkler, limiting heat transfer and thereby reducing the likelihood of heat-induced activation or component damage.

At the upper boundary of the open aperture, the cover includes a circular flange that forms an outwardly extending horizontal lip. Embedded within this flange are internal magnetic elements that provide a secure, yet removable, connection to the metallic bezel of the sprinkler head. This magnetic interface ensures that the cover remains in place during use while enabling quick and tool-free installation and removal. The magnetic engagement also promotes a snug thermal seal, enhancing overall protection.

The uniqueness of this sprinkler cover lies in its combination of thermal insulation, high-heat resistance, and magnetic attachment, a feature set not commonly present in conventional designs. While traditional covers are primarily designed to block debris and impacts, they typically fail in high-temperature environments. This invention fills that gap by incorporating materials and structural features that specifically address heat exposure, offering reliable protection in demanding HVAC and construction settings.

The physical and mechanical performance of the invention is summarized in Table 1, below:

| | | | Standard Range/ | |
|---|---|---|---|---|
| Property | Measured Value | | Requirement | |
| Density | 1.26 | g/cm³ | 1.25 ± 0.05 | g/cm³ |
| Hardness | 51 Shore A | | 50 ± 5 Shore A | |
| Tensile Strength | 5.2 | MPa | ≥5 | MPa |
| Elongation at Break | 410% | | ≥400% | |
| Tear Strength | 15.5 | kN/m | ≥15 | kN/m |
| Heat Resistance | 200° | C. | — | |
| Aging Resistance | HS +6 | | Within +10 | |
| Low Temperature | −40° | C. | Within −40° C. | |
| Resistance | | | | |
| Insulation Breakdown | 22.5 | kV | ≥22 | kV |
| Voltage | | | | |

| | | |
|---|---|---|
| Flame Retardant Grade | V0 | V0 (UL 94 standard) |
| Linear Shrinkage | 3.67% | 3.4%-3.8% |

This data demonstrates the performance characteristics of the silicone used in the product, which can be used to support claims of durability, flexibility, electrical insulation, and flame resistance. The UL 94 V0 flame retardant rating is especially significant for safety-critical applications. Electrical insulation (22.5 kV) and thermal resistance (200° C.) differentiates the disclosed product in technical and safety specs.

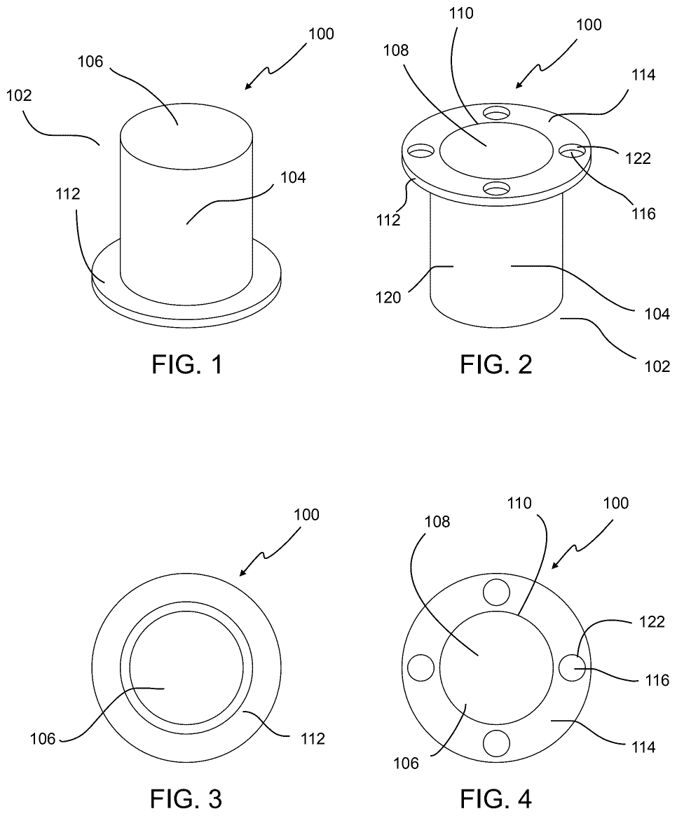

The high-temperature fire sprinkler shield with integrated magnetic coupling of the present invention may be used to enhance thermal protection for fire sprinkler heads in high-heat environments, provide a secure and reliable attachment mechanism using internal magnets, and utilize durable silicone material for optimal performance and flexibility. This thermally insulating and heat-resistant fire sprinkler cover offers a comprehensive solution for protecting sprinkler heads in high-temperature environments. Its innovative design and material composition provide both physical and thermal protection, making it an indispensable tool for ensuring the integrity and reliability of fire suppression systems in challenging conditions. This apparatus and system are particularly shown in FIGS. 1-9.

FIG. 1 illustrates a bottom 3D isometric view of a high-temperature fire sprinkler cover 100. The view shows the overall unitary body 102, including the cylindrical sidewall 104 extending upward from the planar circular base 106, and the outwardly extending circular lip 112 forming a flange at the top of the body.

FIG. 2 illustrates a top 3D isometric view of the fire sprinkler cover 100. This view highlights the hollow internal cavity 108 formed within the unitary body 102, the open upper aperture 110, and the embedded magnetic elements 116 positioned within the horizontal circular lip 114 of the circular flange 112. The magnet apertures 122 housing the magnetic elements 116 are also visible in this view. The unitary body 102, including the circular flange 112, sidewall 104 and other structural components, is formed from silicone material 120, which provides thermal insulation and flexibility.

FIG. 3 illustrates a bottom view of the fire sprinkler cover 100. The view shows the planar circular base 106 and the underside of the circular flange 112, offering a clear perspective of the cover's bottom surface and structural footprint.

FIG. 4 illustrates a top view of the fire sprinkler cover 100. This view emphasizes the hollow internal cavity 108, the open upper aperture 110, and the upper face of the horizontal circular lip 114, with the embedded magnetic elements 116 visible within their respective magnet apertures 122. The circular base 106 can also be seen at the bottom of the internal cavity 108.

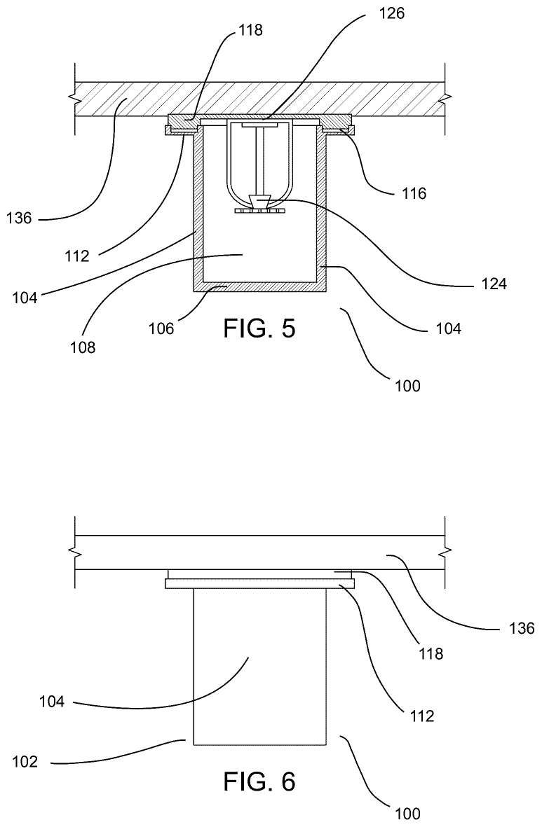

FIG. 5 illustrates a cross-sectional view of the fire sprinkler cover 100 installed onto a sprinkler head 124 of a fire sprinkler system 126. This view shows the magnetic elements 116 engaging with the metallic bezel 118 of the sprinkler head 124. Also visible are the cylindrical sidewall 104, the planar circular base 106, the internal cavity 108, the circular flange 112, and the ceiling tile 136 on which the sprinkler is mounted.

FIG. 6 illustrates the same configuration shown in FIG. 5, presented as an external side elevational view. The view shows the outer profile of the fire sprinkler cover 100, including the unitary body 102 having the cylindrical sidewall 104, the circular flange 112, and its position relative to the ceiling tile and metallic bezel 118 of the sprinkler head.

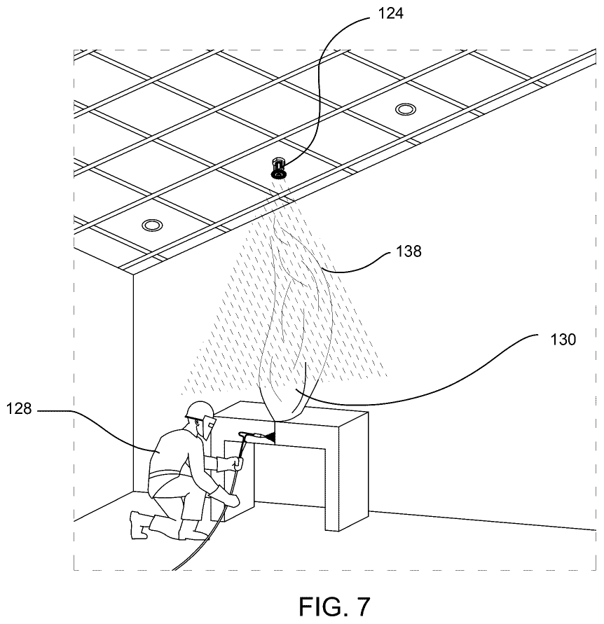

FIG. 7 illustrates a conceptual view of a sprinkler head 124 exposed to high heat without the protective cover. The figure shows a user 128 holding a torch emitting a flame 130, as well as the resulting water spray 138 discharged from the sprinkler due to activation. The image highlights the thermal risk to an unshielded sprinkler under brazing or torch operations.

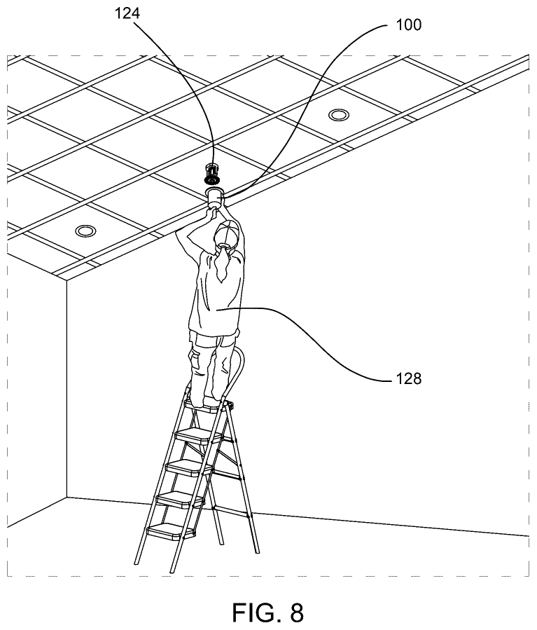

FIG. 8 illustrates a conceptual view of a user 128 installing the fire sprinkler cover 100 over an exposed sprinkler head 124. This image demonstrates how the device is applied by hand prior to conducting high-heat operations, enabling quick and tool-free installation.

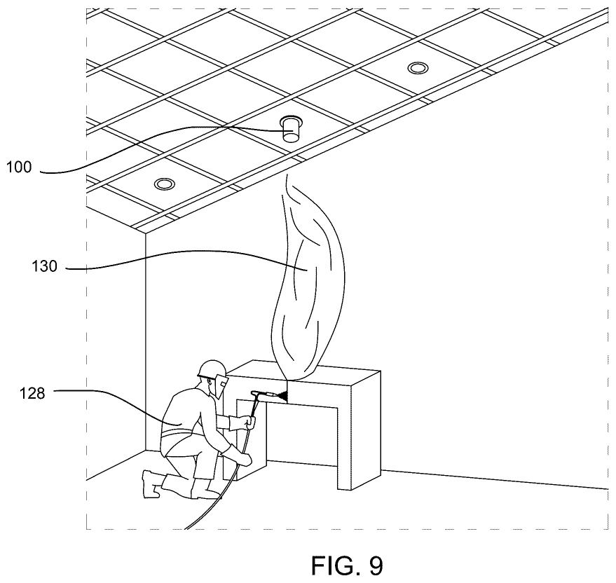

FIG. 9 illustrates a conceptual view similar to FIG. 7, but with the fire sprinkler cover 100 properly installed over the sprinkler head (not visible). A user 128 is shown operating a torch emitting flame 130, and the heat flow is visibly deflected or mitigated, demonstrating the protective barrier provided by the cover during high-heat work.

In an exemplary embodiment, the invention disclosed herein provides a thermally insulating and heat-resistant fire sprinkler cover 100. The fire sprinkler cover 100 comprises a unitary body 102 forming a cylindrical sidewall 104 extending upwardly from a planar circular base 106, thereby creating a hollow internal cavity 108 with an open upper aperture 110 configured to receive a sprinkler head 124 of a fire sprinkler system. The cover 100 further comprises a circular lip 112 forming a flange at an upper boundary of the open upper aperture 110, extending outwardly as a horizontal circular lip 114, wherein the horizontal circular lip 114 includes embedded magnetic elements 116 positioned to magnetically couple with a metallic bezel 118 of the sprinkler head 124. The unitary body 102 is formed from silicone material 120 having a thickness in the range of approximately 1.5 mm to 7 mm.

In some embodiments of the thermally insulating and heat-resistant fire sprinkler cover 100, the silicone material 120 has low thermal conductivity, low chemical reactivity, and low toxicity.

In some embodiments of the thermally insulating and heat-resistant fire sprinkler cover 100, the silicone material 120 has thermal stability up to approximately 260° C. (500° F.) and retains flexibility at temperatures as low as −40° C.

In some embodiments of the thermally insulating and heat-resistant fire sprinkler cover 100, the silicone material 120 is resistant to degradation from oxygen, ozone, and ultraviolet radiation.

In some embodiments of the thermally insulating and heat-resistant fire sprinkler cover 100, the silicone material 120 comprises a base of silicon dioxide or silicon carbide ceramics.

In some embodiments of the thermally insulating and heat-resistant fire sprinkler cover 100, the embedded magnetic elements 116 each have a diameter of approximately 4 mm.

In some embodiments of the thermally insulating and heat-resistant fire sprinkler cover 100, the unitary body 102 has a vertical depth from the base 106 to the upper aperture 110 in the range of approximately 7 cm to 9 cm.

In some embodiments of the thermally insulating and heat-resistant fire sprinkler cover 100, the horizontal circular lip 114 has a thickness in the range of approximately 2 mm to 3 mm.

In some embodiments of the thermally insulating and heat-resistant fire sprinkler cover 100, the silicone material 120 has a density of approximately 1.26 grams per cubic centimeter.

In some embodiments of the thermally insulating and heat-resistant fire sprinkler cover 100, the silicone material 120 has an elongation at break of approximately 410%.

In some embodiments of the thermally insulating and heat-resistant fire sprinkler cover 100, the silicone material 120 has an electrical insulation breakdown voltage of approximately 22.5 kilovolts.

In some embodiments of the thermally insulating and heat-resistant fire sprinkler cover 100, the distance from the base 106 to the midpoint of the cylindrical sidewall 104 is approximately equal to one-half the height of the sprinkler head 124 when enclosed.

In some embodiments of the thermally insulating and heat-resistant fire sprinkler cover 100, the embedded magnetic elements 116 comprise four magnets positioned equidistantly around the circumference of the horizontal circular lip 114.

In some embodiments of the thermally insulating and heat-resistant fire sprinkler cover 100, each of the embedded magnets 116 is removably seated within a corresponding magnet aperture 122 formed in the horizontal circular lip 114.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. A thermally insulating and heat-resistant fire sprinkler cover, comprising:
a unitary body forming a cylindrical sidewall extending upwardly from a planar circular base thereby creating a hollow internal cavity with open upper aperture configured to receive a sprinkler head of a fire sprinkler system;
a circular lip forming a flange at an upper boundary of said open upper aperture extending outwardly as a horizontal circular lip, wherein said horizontal circular lip includes embedded magnetic elements positioned to a magnetically couple with a metallic bezel of the sprinkler head; and
wherein said unitary body is formed from silicone material having a thickness in the range of approximately 1.5 mm-7 mm.

2. The thermally insulating and heat-resistant fire sprinkler cover, as recited in claim 1, wherein the silicone material has low thermal conductivity, low chemical reactivity, and low toxicity.

3. The thermally insulating and heat-resistant fire sprinkler cover, as recited in claim 2, wherein the silicone material has thermal stability up to approximately 260° C. (500° F.) and retains flexibility at temperatures as low as −40° C.

4. The thermally insulating and heat-resistant fire sprinkler cover, as recited in claim 3, wherein the silicone material is resistant to degradation from oxygen, ozone, and ultraviolet radiation.

5. The thermally insulating and heat-resistant fire sprinkler cover, as recited in claim 4, wherein the silicone material comprises a base of silicon dioxide or silicon carbide ceramics.

6. The thermally insulating and heat-resistant fire sprinkler cover, as recited in claim 1, wherein the embedded magnetic elements each have a diameter of approximately 4 mm.

7. The thermally insulating and heat-resistant fire sprinkler cover, as recited in claim 1, wherein the unitary body has a vertical depth from the base to the upper aperture in the range of approximately 7 cm to 9 cm.

8. The thermally insulating and heat-resistant fire sprinkler cover, as recited in claim 6, wherein the horizontal circular lip has a thickness in the range of approximately 2 mm to 3 mm.

9. The thermally insulating and heat-resistant fire sprinkler cover, as recited in claim 1, wherein the silicone material has a density of approximately 1.26 grams per cubic centimeter.

10. The thermally insulating and heat-resistant fire sprinkler cover, as recited in claim 1, wherein the silicone material has an elongation at break of approximately 410%.

11. The thermally insulating and heat-resistant fire sprinkler cover, as recited in claim 1, wherein the silicone material has an electrical insulation breakdown voltage of approximately 22.5 kilovolts.

12. The thermally insulating and heat-resistant fire sprinkler cover, as recited in claim 1, wherein the distance from the base of the cover to the midpoint of the cylindrical sidewall is approximately equal to one-half the height of the sprinkler head when enclosed.

13. The thermally insulating and heat-resistant fire sprinkler cover, as recited in claim 1, wherein the embedded magnetic elements comprise four magnets positioned equidistantly around the circumference of the horizontal circular lip.

14. The thermally insulating and heat-resistant fire sprinkler cover, as recited in claim 13, wherein each of the magnets is removably seated within a corresponding magnet aperture formed in the horizontal circular lip.
